(19) United States
(12) Patent Application Publication
(10) Pub. No.: US 2009/0087680 A1
(43) Pub. Date: Apr. 2, 2009

(54) Coated metal product and manufacturing method thereof

(75) Inventors: Hideaki Takada, Saitama (JP); Kenji Suto, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/284,680

(22) Filed: Sep. 24, 2008

(30) Foreign Application Priority Data
Sep. 28, 2007 (JP) 2007-255014

(51) Int. Cl. B32B 3/10; B05D 5/00; B05D 1/36

(52) U.S. Cl. 428/601; 427/261

(57) ABSTRACT

A coated metal product is disclosed in which the surface of a ferrous component is coated using an anticorrosive layer, and the surface of the anticorrosive layer is coated using a coating film. The coating film has numerous very small uncoated portions for exposing the surface of the anticorrosive layer to the exterior of the coated metal product, rather than the entire surface of the anticorrosive layer being coated.

### FIELD OF THE INVENTION

The present invention relates to a coated metal product in which a ferrous component is coated using an anticorrosive layer and in which the anticorrosive layer is coated with a coating film, and to a method for manufacturing the product.

### BACKGROUND OF THE INVENTION

Steel and other ferrous components are used as products after undergoing an anticorrosive treatment. In particular, outboard engines and other products used in locations that become wet with water are coated with an anticorrosive layer.

An aqueous anticorrosive metal material as an anticorrosive-treated metal is conventionally known, as disclosed in Japanese Patent Application Laid-Open Publication No. 05-086484 (JP 05-086484 A).

FIGS. 8A and 8B hereof show the aqueous anticorrosive metal material disclosed in JP 05-086484 A.

The aqueous anticorrosive metal material 100 is composed of a steel material 101, which is a ferrous component, and a coating layer 102 for coating the steel material 101, as shown in FIG. 8A. The coating layer 102 is a composition composed of chromium trioxide and a metal salt of dihydrogen phosphate.

There are occasions in which a product using the aqueous anticorrosive metal material 100 is damaged during use by a scratch 103 on a surface of the aqueous anticorrosive metal material 100 due to an impact or the like from the exterior. When water 104 adheres to the coating layer 102, a chemical reaction occurs between the water, and the chromium trioxide and the metal salt of dihydrogen phosphate contained in the coating layer 102.

The coating layer 102 shown by imaginary lines in FIG. 8B sags as shown by the arrows h due to this reaction, whereby the coating layer 102 is formed on the surface where the steel material 101 is exposed by the scratch 103, and the surface of the exposed steel material 101 is prevented from being corroded.

Conventionally, however, there are occasions when a coating is applied to the surface of the aqueous anticorrosive metal material 100 in order to improve the external appearance of the product.

FIGS. 9A and 9B show the state of a coating applied to the aqueous anticorrosive metal material 100.

When a coating is applied to the aqueous anticorrosive metal material 100, a film 105 is formed on the surface of the aqueous anticorrosive metal material 100, as shown in FIG. 9A. A scratch 103 may be formed during use of the aqueous anticorrosive metal material 100 by an impact or the like from the exterior to the coated aqueous anticorrosive metal material 100.

When a scratch 103 is formed in the aqueous anticorrosive metal material 100 having a film 105, water 104 adheres to the coating layer 102 and the film 105, and therefore does not adhere sufficiently to the coating layer 102.

When water does not to adhere sufficiently to the coating layer 102 shown by the imaginary lines in FIG. 9B, a new coating layer 106 is formed only in a portion of the exposed surface of the steel material 101. When this occurs, corrosion occurs in portions of the steel material 101 not covered by the new coating layer 106.

### SUMMARY OF THE INVENTION

An object of the present invention is to provide a coated metal product that can be used to coat a ferrous component without degradation in an anticorrosive function.

According to one aspect of the present invention, there is provided a coated metal product comprising a ferrous component, an anticorrosive layer containing an aluminum-zinc composite material coated onto the ferrous component, and a coating film with which the anticorrosive layer is coated, wherein the coating film has numerous very small uncoated portions formed so that the surface of the anticorrosive layer is exposed to the exterior of the coated metal product.

When a scratch is formed on the coated metal product, water adheres to the anticorrosive layer. When water adheres to the anticorrosive layer, the water and the aluminum-zinc composite material contained in the anticorrosive layer cause a chemical reaction. The hydroxides formed by the reaction sag, and the exposed ferrous component is covered by the anticorrosive layer.

The coated metal product has uncoated portions, and the surface of the anticorrosive layer is exposed to the exterior. For this reason, when a scratch is formed on the coated metal product, water readily adheres to the anticorrosive layer. In other words, since the surface of the anticorrosive layer is exposed, a sufficient amount of water can adhere to the anticorrosive layer in order for the ferrous component exposed by the scratch 103 to be covered. Therefore, the anticorrosive function is not reduced even when coated.

It is preferred that the coating film be an assembly of very small dots or an assembly of stripes of a very small width, and the spaces between the dots and the spaces between the stripes are the uncoated portions. After the surface of the anticorrosive layer is covered by a mask, the assembly of dots or the assembly of stripes can readily be coated. Therefore, the coated metal product can be manufactured by simple means, work is carried out in a short time, and the technique is beneficial.

The coating film is preferably a net pattern, and a mesh of the net is the uncoated portion.

According to another aspect of the present invention, a method for manufacturing a coated metal product is provided, which method comprising the steps of: coating an anticorrosive layer containing an aluminum-zinc composite material onto the ferrous component, and coating the anticorrosive layer with a coating film having numerous very small uncoated portions formed so that the surface of the anticorrosive layer is exposed to the exterior of the coated metal product.

When a scratch is formed on the coated metal product, water adheres to the anticorrosive layer. Adherence of water causes a chemical reaction between the water and an aluminum-zinc composite material contained in the anticorrosive layer. The hydroxides formed by the reaction sag, and the exposed ferrous component is covered by the anticorrosive layer.

The coated metal product has passageways, and the exterior is connected to the anticorrosive layer. Since the anticorrosive layer is exposed, water readily adheres to the anticorrosive layer when a scratch is formed on the coated metal product. In other words, a sufficient amount of water can adhere to the anticorrosive layer in order for the ferrous component exposed by the scratch to be covered. Therefore, the anticorrosive function is not reduced even when coated.

Using the manufacturing method according to the present invention, a coated metal product that has been coated without a reduction in the anticorrosive function can be obtained.

### BRIEF DESCRIPTION OF THE DRAWINGS

Certain preferred embodiments of the present invention will be described in detail below, by way of example only, with reference to the accompanying drawings, in which:

FIG. 1 is a cross-sectional view of a coated metal product according to a first embodiment of the present invention;

FIG. 2 is a view from arrow 2 in FIG. 1;

FIGS. 3A and 3B are views showing an effect of the coated metal product of the first embodiment shown in FIG. 1;

FIG. 4 is a top view of a coated metal product according to a second embodiment of the present invention;

FIG. 5 is a cross-sectional view taken along line 5-5 of FIG. 4;

FIG. 6 is a top view of a coated metal product according to a third embodiment of the present invention;

FIG. 7 is a cross-sectional view taken along line 7-7 of FIG. 6;

FIGS. 8A and 8B are cross-sectional views of an aqueous anticorrosive metal material of the prior art; and

FIGS. 9A and 9B are cross-sectional views showing the prior art in which a coating is applied to the surface of an aqueous anticorrosive metal material.

### DETAILED DESCRIPTION OF THE PREFERRED EMBODIMENTS

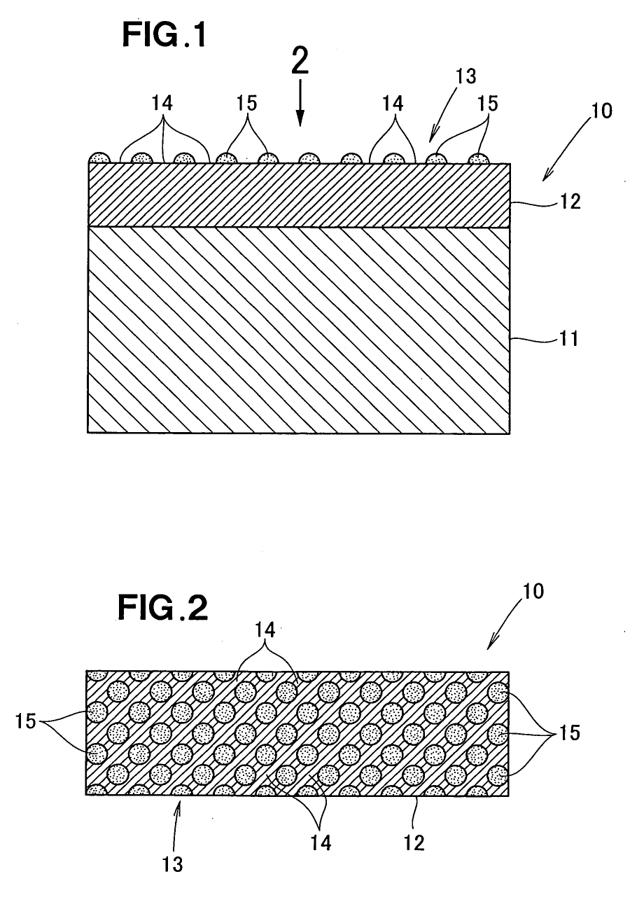

A coated metal product 10 according to a first embodiment is composed of a steel or other ferrous component 11, an anticorrosive layer 12 containing an aluminum-zinc composite material that is coated onto the surface of the ferrous component 11, a coating film 13 with which the anticorrosive layer 12 is coated, and an uncoated portion 14 provided so that the anticorrosive layer 12 is exposed to the exterior of the coated metal product 10, as seen in FIG. 1.

The coated metal product 10 according to the present invention is manufactured by a first step for coating an anticorrosive layer 12 onto a ferrous component 11, and a second step for coating the anticorrosive layer 12 with a coating film 13 having numerous very small uncoated portions 14 formed so that the anticorrosive layer 12 is exposed to the exterior.

For example, the ferrous component 11 is covered by the anticorrosive layer 12 using a dipping treatment in the first step. The anticorrosive layer 12 is covered by the coating film 13 using an inkjet printer in the second step.

The dipping treatment is preferred as the method for coating the anticorrosive layer 12 in the first step, but a diffusion coating process, a spraying process, or a cladding process may also be used.

The method using an ink jet printer is preferred as the method for coating the coating film 13 in the second step, but brush coating, roller coating, spraying, electrostatic coating, or the like may also be used.

The coating film 13 is composed of a plurality of very small dots (coated portions) 15 and uncoated portions 14, as shown by FIG. 2.

The dots 15 are very small to the extent they cannot be seen. Therefore, the coated metal product 10 can be coated with various colors or patterns in the same manner as in the case of conventional coating.

The dot-shape coating film can readily be formed when an ink jet printer is used for coating in the second step. Therefore, the coated metal product 10 can be manufactured by simple means, work is carried out in a short time, and the technique is beneficial.

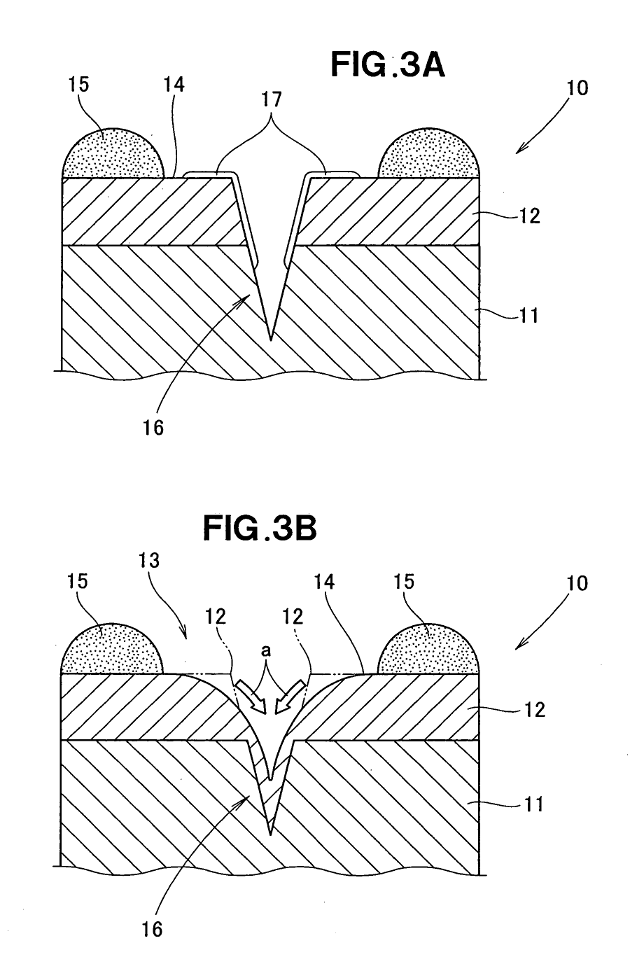

FIGS. 3A and 3B show the state of the anticorrosive layer when the coated metal product has been scratched.

There are occasions in which a scratch 16 is formed on the coated metal product 10 by an impact or the like from the exterior, as shown in FIG. 3A. When water 17 adheres to the anticorrosive layer 12 in such cases, the water 17 and an aluminum-zinc composite material contained in the anticorrosive layer 12 causes a reaction such as the one shown in the chemical formulas below.

Zn⁺⁺+2OH⁻→Zn(OH)₂

Al³⁺+3OH⁻→Al(OH)₃

When the reaction occurs, the hydroxides Zn(OH)₂ and Al(OH)₃ of the anticorrosive layer 12 shown by imaginary lines in FIG. 3B sag in the manner shown by the arrows a, and the portion of the ferrous component 11 exposed by the scratch 16 is covered. The ferrous component 11 is covered by the hydroxide, and therefore prevents corrosion without oxidizing. In other words, the anticorrosive function can be preserved.

The coated metal product 10 has uncoated portions 14, and the anticorrosive layer 12 is exposed to the exterior, as shown in FIG. 3A. Because of this, when a scratch 16 is formed on the coated metal product 10, water 17 readily adheres to the anticorrosive layer 12. In other words, since the anticorrosive layer 12 is exposed to the exterior, a sufficient amount of water 17 can adhere to the anticorrosive layer 12 in order for the ferrous component 11 exposed by the scratch 16 to be covered. Therefore, the anticorrosive function is not reduced even when coated.

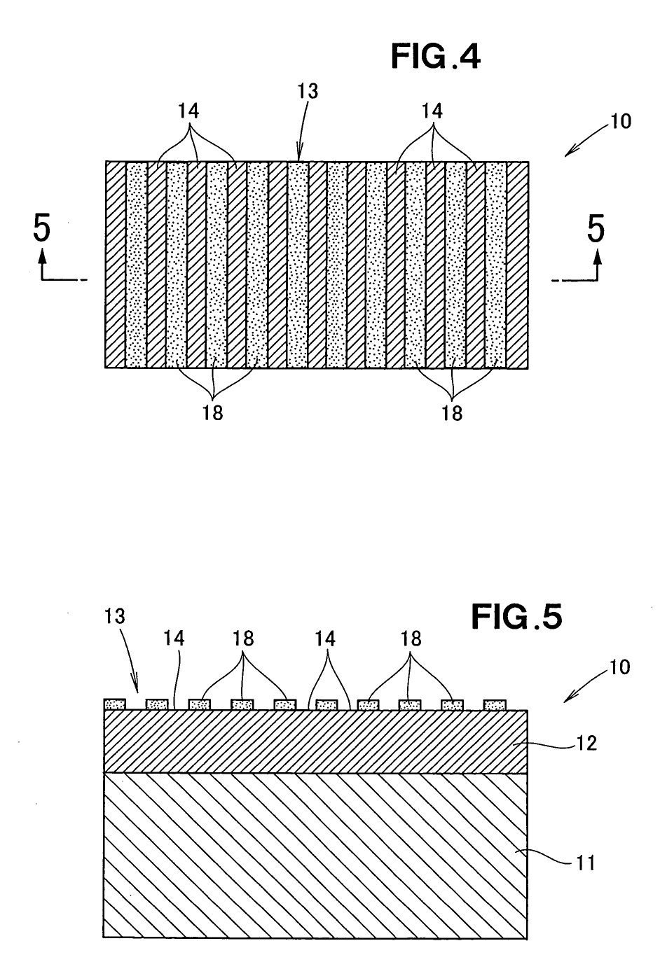

FIGS. 4 and 5 show a coated metal product according to a second embodiment. Since elements are the same as the coated metal product according to the first embodiment shown in FIGS. 1 and 2, the same reference numerals are used for the same constituent elements, and a detailed description thereof is omitted.

The coating film 13 according to the second embodiment is composed of stripes 18 that are the coated portion, and the uncoated portions 14, as shown in FIG. 4.

In the case of stripes 18 as well, an uncoated portion 14 is formed between the stripes 18, 18, whereby an effect can be obtained wherein the product is coated without a reduction in the anticorrosive function, as shown in FIG. 5.

For example, after an anticorrosive layer 12 is covered by a striped pattern mask, a roller coating operation can readily form a coating film 13. Therefore, the coated metal product can be manufactured by simple means, and work is carried out in a short time.

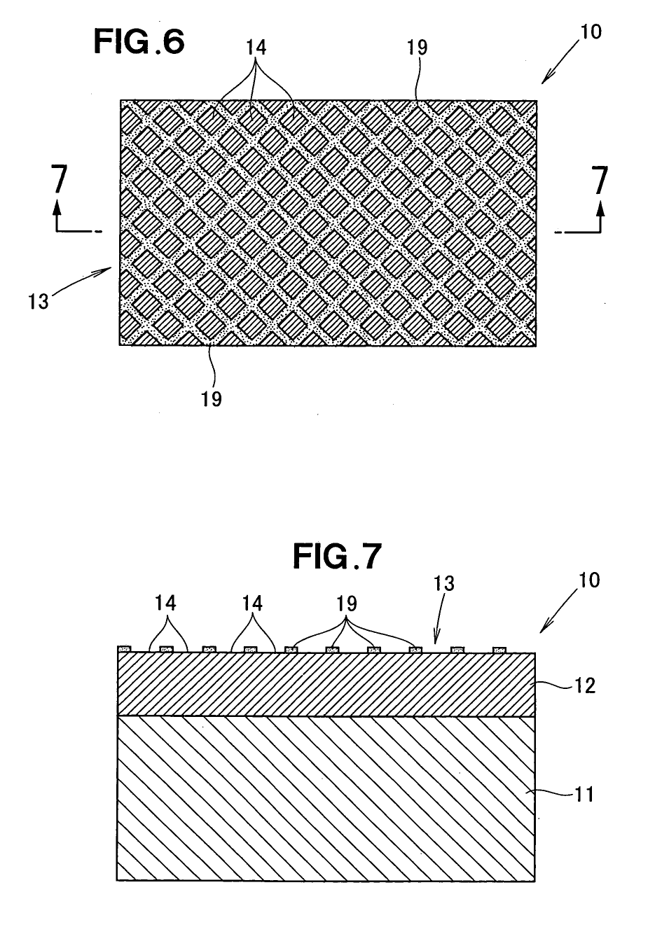

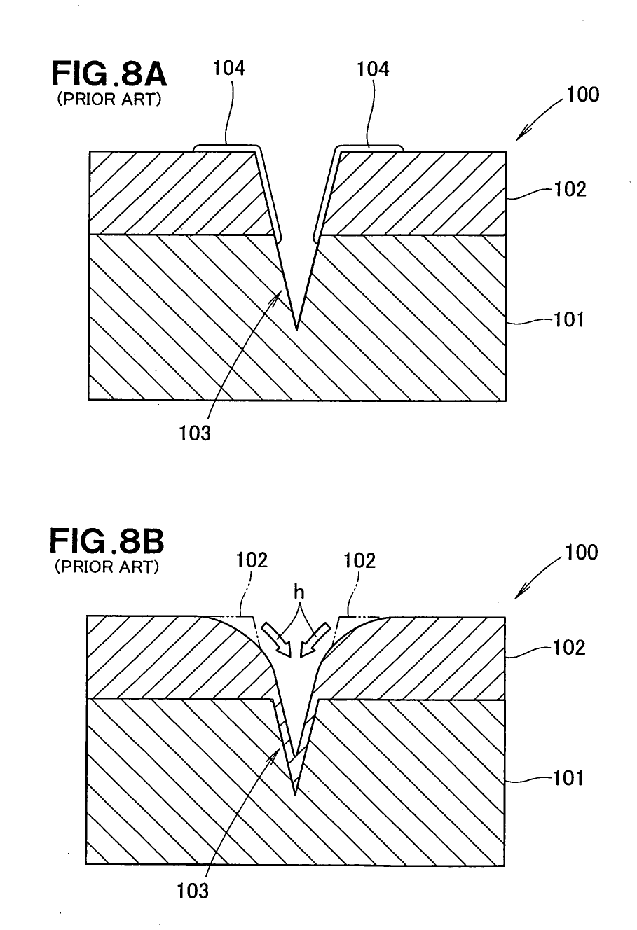

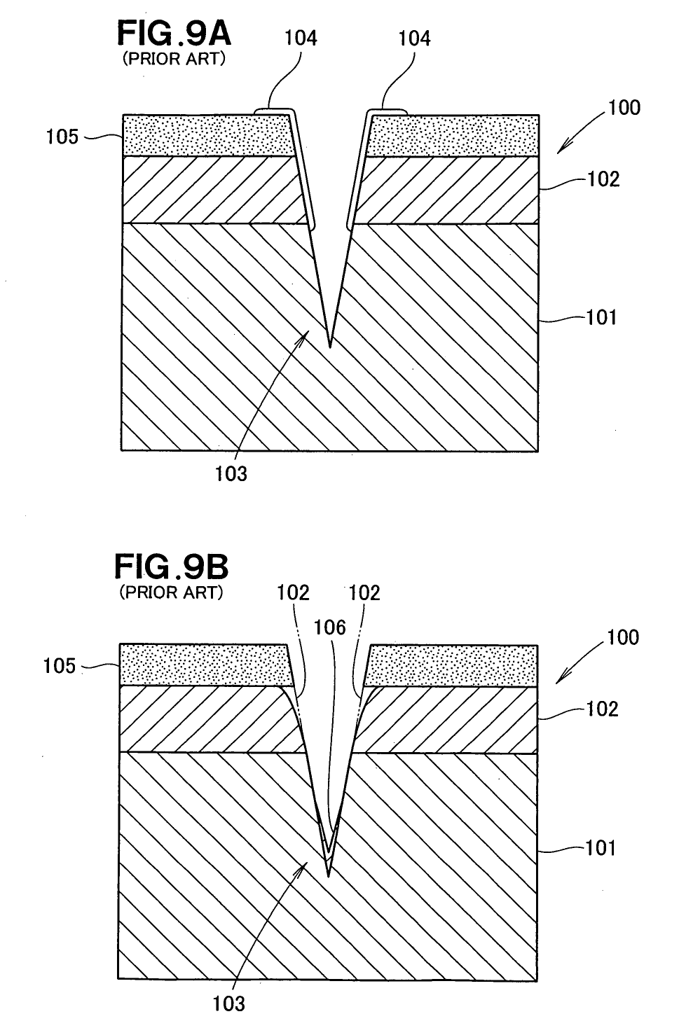

FIGS. 6A and 6B show a coated metal product according to a third embodiment. Since elements are the same as the coated metal product according to the first embodiment, the same reference numerals are used for the same constituent elements, and a detailed description thereof is omitted.

The coated metal product 10 according to the third embodiment is coated so as to achieve a net pattern 19, and the mesh of the net is the uncoated portion 14, as shown in FIG. 6A.

When the coated metal product 10 is coated in a net pattern 19, the mesh is the uncoated portion 14, and an effect can be obtained wherein the product is coated without a reduction in the anticorrosive function, as shown in FIG. 7. The product is coated without a reduction in the anticorrosive function even when the uncoated portions 14 are formed in a discontinuous manner.

For example, after an anticorrosive layer 12 is covered by a net pattern mask, a net pattern 19 can be easily formed by spraying. Therefore, the coated metal product 10 can be manufactured by simple means, and work can be carried out in a short time.

In the embodiments, examples were described in which the coating film 13 is a pattern of dots, stripes, or a net, but the present invention is not limited to these patterns. A configuration is also possible in which numerous very small uncoated portions 14 are provided so that the anticorrosive layer 12 is exposed to the exterior of the coated metal product 10.

The coated metal product 10 according to the present invention can be used not only in an outboard engine but also in environments where water can adhere to the anticorrosive layer 12 in a device for mounting an outboard engine, a device for mounting an inboard engine, a component used in vehicle undercarriages, and the like. The product according to the present invention is not limited to these applications alone, however.

Obviously, various minor changes and modifications of the present invention are possible in light of the above teaching. It is therefore to be understood that within the scope of the appended claims the invention may be practiced otherwise than as specifically described.

What is claimed is:

1. A coated metal product comprising:
a ferrous component;
an anticorrosive layer containing an aluminum-zinc composite material coated onto the ferrous component; and
a coating film with which the anticorrosive layer is coated; wherein
the coating film has numerous very small uncoated portions formed so that the surface of the anticorrosive layer is exposed to the exterior of the coated metal product.

2. The product of claim 1, wherein the coating film is an assembly of very small dots or an assembly of stripes of a very small width, and the spaces between the dots and the spaces between the stripes are the uncoated portions.

3. The product of claim 1, wherein the coating film is a net pattern, and a mesh of the net is the uncoated portion.

4. A method for manufacturing a coated metal product, comprising the steps of:
coating an anticorrosive layer containing an aluminum-zinc composite material onto the ferrous component; and
coating the anticorrosive layer with a coating film having numerous very small uncoated portions formed so that the surface of the anticorrosive layer is exposed to the exterior of the coated metal product.
